(19) United States
(12) Patent Application Publication
(10) Pub. No.: US 2013/0142483 A1
(43) Pub. Date: Jun. 6, 2013

(54) ARRAYED WAVEGUIDE GRATING MULTIPLEXER-DEMULTIPLEXER

(71) Applicant: FURUKAWA ELECTRIC CO., LTD., Tokyo (JP)

(72) Inventors: Junichi Hasegawa, Tokyo (JP); Kazutaka Nara, Tokyo (JP)

(73) Assignee: FURUKAWA ELECTRIC CO., LTD., Tokyo (JP)

(21) Appl. No.: 13/753,929

(22) Filed: Jan. 30, 2013

Related U.S. Application Data
(63) Continuation of application No. PCT/JP2012/067979, filed on Jul. 13, 2012.

(30) Foreign Application Priority Data
Sep. 9, 2011 (JP) JP2011-197584

(51) Int. Cl. G02B 6/34

(52) U.S. Cl. CPC G02B 6/34
USPC 385/37

(57) ABSTRACT

A multiplexer-demultiplexer including: an AWG chip including a first input-output waveguide, a first slab waveguide connected thereto, an arrayed waveguide connected thereto and formed of parallel channel waveguides of different lengths, a second slab waveguide connected thereto, and second input-output waveguides connected thereto; a base plate joined to an underside of the chip; a fixed piece and a movable piece formed by the chip and the base plate being cut across the first or second slab waveguide; a reference plate to which the fixed piece is joined and against which the movable piece is abutted; a member bridging between these pieces and compensating a temperature-dependent shift of a light transmission center wavelength of the multiplexer-demultiplexer by expanding/contracting according to a temperature change and changing relative positions of the pieces; and a clip sandwiching the reference plate and the movable piece allowing the piece to slide on the plate.

### CROSS-REFERENCE TO RELATED APPLICATIONS

This application is a continuation of PCT International Application No. PCT/JP2012/067979 filed on Jul. 13, 2012, which claims the benefit of priority from the prior Japanese Patent Application No. 2011-197584 filed on Sep. 9, 2011. The entire contents of the PCT international application and the prior Japanese patent application are incorporated herein by reference.

### BACKGROUND OF THE INVENTION

1. Field of the Disclosure

The present invention relates to an arrayed waveguide grating multiplexer-demultiplexer.

2. Description of the Related Art

Transmission center wavelengths of wavelength multiplexer-demultiplexers using arrayed waveguide gratings (AWG) are known to be temperature dependent because a refractive index of their constituent material, silica based glass, is temperature dependent.

The temperature dependence dX/dT of the transmission center wavelength of an AWG formed of silica based glass is 0.011 nm/° C., and this is a large value not negligible for use in a dense-wavelength division multiplexing (D-WDM) transmission system.

To resolve the temperature dependence, there is a technique for controlling temperature of an AWG to be constant by a heating element and a cooling element that use electric power. However, for D-WDM transmission systems that are getting more diversified recently, athermalization (achievement of temperature independence) not requiring electric power is strongly demanded.

An arrayed waveguide grating multiplexer-demultiplexer (hereinafter, referred to as an AWG multiplexer-demultiplexer as appropriate) that realizes athermalization using a compensation member is disclosed in Japanese Patent No. 3764105. The AWG multiplexer-demultiplexer of Japanese Patent No. 3764105 has a configuration of which an AWG chip is cut across a slab waveguide and a compensation member having a predetermined thermal expansion coefficient is provided such that the compensation member bridges over portions separated by the cutting. When temperature of this AWG multiplexer-demultiplexer changes, the compensation member expands/contracts and changes relative positions of the separated portions. An amount of change in the relative positions is adjusted to be an amount of change that compensates a shift in the transmission center wavelength that is dependent on temperature change. The athermalization of the AWG multiplexer-demultiplexer is thereby realized.

### SUMMARY

### Technical Problem

To realize stable optical properties in the AWG multiplexer-demultiplexer of Japanese Patent No. 3764105, an optical axis needs to be precisely adjusted and maintained between the separated portions of the AWG chip. Thus, the AWG chip is sandwiched at the separated portions of the AWG chip by a clip from an upper side and a lower side and a pressure is applied to thereby maintain the adjusted optical axis. Further, as to the AWG multiplexer-demultiplexer of Japanese Patent No. 3764105, a configuration is also disclosed where a holding substrate is interposed and sandwiched between the clip and the AWG chip.

However, in the AWG multiplexer-demultiplexer of Japanese Patent No. 3764105, the structure of the clip and the holding substrate for maintaining the optical axis is complex, large, and expensive.

Accordingly, there is a need to provide an arrayed waveguide grating multiplexer-demultiplexer that is inexpensive and has stable optical properties.

### SUMMARY OF THE INVENTION

According to an embodiment of the present invention, an arrayed waveguide grating multiplexer-demultiplexer includes: an arrayed waveguide grating chip including: a first input-output waveguide to and from which light is input and output; a first slab waveguide connected to the first input-output waveguide; an arrayed waveguide connected to the first slab waveguide and formed of a plurality of channel waveguides that have mutually different lengths and are arranged parallel to one another; a second slab waveguide connected to the arrayed waveguide; and a plurality of second input-output waveguides connected to the second slab waveguide, and to and from which light is input and output; a base plate joined to an underside of the arrayed waveguide grating chip; a fixed piece and a movable piece that are formed by the arrayed waveguide grating chip and the base plate being cut into a plurality of pieces at at least one of a cut surface crossing the first slab waveguide and a cut surface crossing the second slab waveguide; a reference plate to which the fixed piece is joined and against which the movable piece is abutted; one or more compensation member or members that is or are provided to bridge between the fixed piece and the movable piece, and compensates a temperature-dependent shift of a light transmission center wavelength of the arrayed waveguide grating multiplexer-demultiplexer by expanding or contracting according to a temperature change and changing relative positions of the fixed piece and the movable piece; and one or more clip or clips that sandwiches or sandwich the reference plate and the movable piece so as to allow the movable piece to slide on the reference plate.

The above and other objects, features, advantages and technical and industrial significance of this invention will be better understood by reading the following detailed description of presently preferred embodiment of the invention, when considered in connection with the accompanying drawings.

### BRIEF DESCRIPTION OF THE DRAWINGS

FIG. 1 is a schematic top view of an AWG multiplexer-demultiplexer according to an embodiment;

FIG. 2 is a rear view of the AWG multiplexer-demultiplexer illustrated in FIG. 1;

FIG. 3 is a cross-sectional view along line X-X of the AWG multiplexer-demultiplexer illustrated in FIG. 1;

FIG. 4 is a diagram illustrating a method of manufacturing an AWG chip illustrated in FIG. 1;

FIG. 5 is a schematic perspective view of a clip illustrated in FIG. 1;

FIG. 6 is a schematic top view of a reference plate according to a modified example 1;

FIG. 7 is a side view illustrating a state where a fixed piece is joined to, and a movable piece is abutted against, the reference plate illustrated in FIG. 5;

FIG. 8 is a schematic side view illustrating a state where a fixed piece is joined to, and a movable piece is abutted against, a reference plate according to a modified example 2;

FIG. 9 is a schematic top view of a reference plate according to a modified example 3;

FIG. 10 is a side view illustrating a state where a fixed piece is joined to, and a movable piece is abutted against, the reference plate illustrated in FIG. 9;

FIG. 11 is a schematic side view illustrating a state where a fixed piece is joined to, and a movable piece is abutted against, a reference plate according to a modified example 4;

FIG. 12 is a diagram illustrating circuit parameters of an AWG multiplexer-demultiplexer of an example; and

FIG. 13 is a diagram illustrating temperature dependence of a variation in transmission center wavelength of the AWG multiplexer-demultiplexer of the example.

### DETAILED DESCRIPTION OF THE INVENTION

Hereinafter, embodiments of an arrayed waveguide grating multiplexer-demultiplexer according to the present invention will be described in detail with reference to the drawings. The present invention is not limited by these embodiments. Further, the same or corresponding elements in the drawings are denoted with the same reference numerals as appropriate. Furthermore, it is to be noted that the drawings are schematic, and that the relation between the thickness and the width of each layer, the proportion of each layer, and the like may be different from those of the actual. A portion may be included whose dimensional relations or proportions differ among the drawings.

### Embodiment

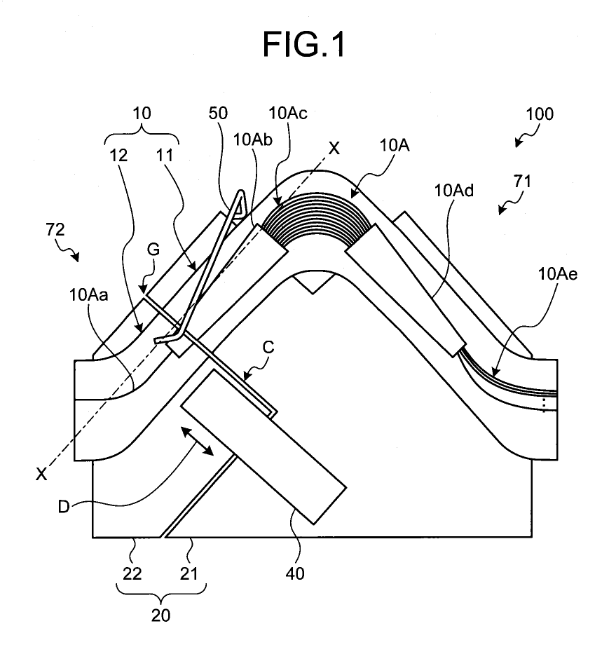

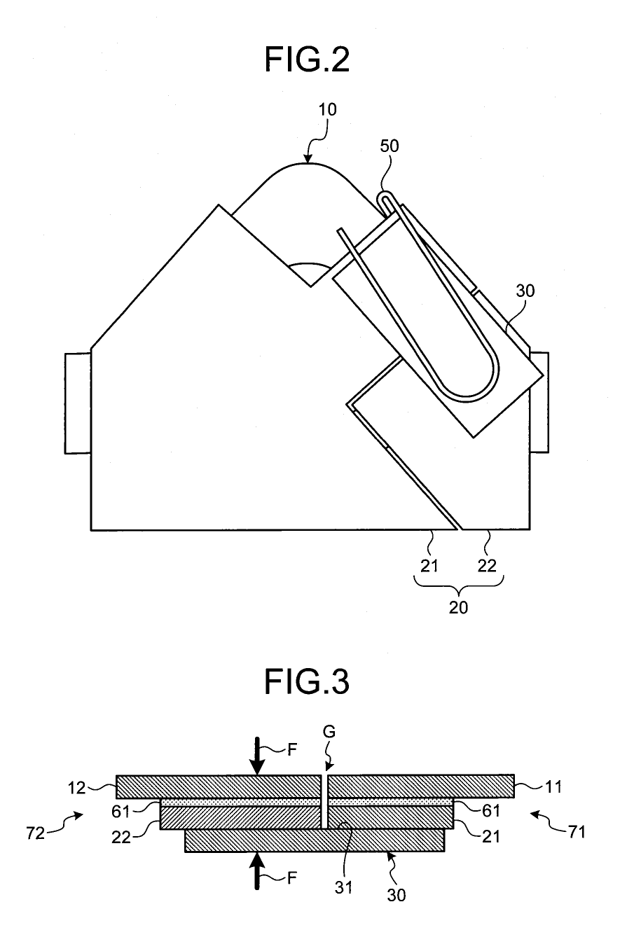

FIG. 1 is a schematic top view of an AWG multiplexer-demultiplexer 100 according to an embodiment. FIG. 2 is a rear view of the AWG multiplexer-demultiplexer 100 illustrated in FIG. 1. FIG. 3 is a cross-sectional view along line X-X of the AWG multiplexer-demultiplexer 100 illustrated in FIG. 1.

As illustrated in FIGS. 1 to 3, the AWG multiplexer-demultiplexer 100 includes an AWG chip 10, a base plate 20, a reference plate 30, a compensation member 40, and a clip 50.

The AWG chip 10 is a planar lightwave circuit (PLC) chip of which, on a substrate formed of silicon, silica glass, or the like, respective waveguides, which compose an AWG 10A and are formed of silica based glass, are formed, the waveguides being a first input-output waveguide 10Aa to and from which light is input and output, a first slab waveguide 10Ab connected to the first input-output waveguide 10Aa, an arrayed waveguide 10Ac connected to the first slab waveguide 10Ab, a second slab waveguide 10Ad connected to the arrayed waveguide 10Ac, and a plurality of second input-output waveguides 10Ae connected to the second slab waveguide 10Ad and to and from which light is input and output.

The arrayed waveguide 10Ac is a parallel arrangement of channel waveguides having lengths different from one another at a predetermined pitch. These channel waveguides are bent arc-shaped, and are sequentially arranged in ascending order of their lengths from an inner side to an outer side of the arc. Differences in optical path lengths between adjacent channel waveguides are the same. Further, the number of channel waveguides is set according to the number of channels of WDM signal light that is input, and is 100, for example.

The first slab waveguide 10Ab and the second slab waveguide 10Ad are linearly formed. Further, the first input-output waveguide 10Aa and the plurality of second input-output waveguides 10Ae are bent arc-shaped in a direction opposite to the arrayed waveguide 10Ac. The number of the plurality of second input-output waveguides 10Ae is set to be the number of channels of WDM signal light that is used, and is 40, for example. Further, the AWG chip 10 has a shape bent along an outline shape of the AWG 10A (a boomerang shape).

As illustrated in FIG. 3, the base plate 20 is joined to an underside of the AWG chip 10 by an adhesive 61. The base plate 20 is made of silica glass, for example. The base plate 20 is preferably made of a material having a linear thermal expansion coefficient substantially equal to that of the AWG chip 10, but not particularly limited thereto.

The AWG chip 10 and the base plate 20 are cut in two at a cut surface C in a state of being joined to each other, and are separated into a fixed piece 71 and a movable piece 72. The cut surface C crosses the first slab waveguide 10Ab along a direction substantially vertical to a longitudinal direction of the first slab waveguide 10Ab, and is bent at substantially 90 degrees in the middle. Of the separated AWG chip 10 and base plate 20, those included in the fixed piece 71 are referred to as an AWG chip piece 11 and a base plate piece 21, respectively. Further, those included in the movable piece 72 are referred to as an AWG chip piece 12 and a base plate piece 22, respectively. The fixed piece 71 and the movable piece 72 are arranged with a groove G formed by the cut surface C therebetween. To suppress reflection and optical loss due to the groove G in the first slab waveguide 10Ab, the groove G is preferably filled with a matching oil or a matching grease.

As illustrated in FIG. 3, the fixed piece 71 is joined to, and the movable piece 72 is abutted against, the reference plate 30. That is, the fixed piece 71 is joined to a predetermined region 31 on a surface by an adhesive or the like. The movable piece 72 is not joined to the fixed piece 71. The material forming the reference plate 30 is not particularly limited, but silica glass may be used, for example.

The compensation member 40 is plate-shaped, provided to bridge between the fixed piece 71 and the movable piece 72, and joined to each of the fixed piece 71 and the movable piece 72 by an adhesive or the like. Further, the compensation member 40 extends substantially in parallel with the cut surface C of the first slab waveguide 10Ab. In the present embodiment, since the AWG chip 10 has the boomerang shape that follows along the shape of the AWG 10A, there is no space on the AWG chip 10 to join the compensation member 40. Therefore, the compensation member 40 is joined to the base plate pieces 21 and 22. The compensation member 40 may be made of a metal such as copper, pure aluminum (JIS: A1050), or the like.

As illustrated in FIGS. 1 and 2, the clip 50 sandwiches the reference plate 30 and the movable piece 72. A pressing force F as illustrated in FIG. 3 is thereby applied to the reference plate 30 and the movable piece 72, and the pressing force F is set to a value by which the movable piece 72 is able to slide on the reference plate 30. As the clip 50, one that is formed by bending one rod of a metal such as steel, like a so-called Gem clip, may be used.

Next, an operation of the AWG multiplexer-demultiplexer 100 will be described.

In the AWG chip 10 of the AWG multiplexer-demultiplexer 100, when WDM signal light of which signal light beams of mutually different wavelengths are multiplexed is input from the first input-output waveguide 10Aa, the first slab waveguide 10Ab causes the WDM signal light input from the first input-output waveguide 10Aa to be broadened by diffraction and input to the arrayed waveguide 10Ac. The arrayed waveguide 10Ac adds a phase difference to the signal light beams included in the WDM signal light, and causes them to be input to the second slab waveguide 10Ad. The second slab waveguide 10Ad condenses the light beams of different wavelengths to the plurality of second input-output waveguides 10Ae respectively with the phase difference added by the arrayed waveguide 10Ac. As a result, the signal light beams with mutually different wavelengths are demultiplexed and output respectively from the plurality of second input-output waveguides 10Ae. As described, the AWG multiplexer-demultiplexer 100 functions as a demultiplexer for wavelength-multiplexed light.

On the contrary, when signal light beams of different wavelengths are input respectively from the plurality of second input-output waveguides 10Ae, actions opposite to the actions described above occur due to reciprocity of light, and WDM signal light of which signal light beams input from the plurality of second input-output waveguides 10Ae are multiplexed is output from the first input-output waveguide 10Aa. In this case, the AWG multiplexer-demultiplexer 100 functions as a multiplexer for wavelength-multiplexed light. Thus, the AWG multiplexer-demultiplexer 100 functions as a multiplexer-demultiplexer for wavelength-multiplexed light.

In usual AWG chips, a refractive index of a material forming the AWG chips is temperature dependent, and thus, when temperatures of the AWG chips change, wavelengths of light to be respectively condensed to the plurality of second input-output waveguides are shifted from wavelengths intended to be condensed. As a result, light transmission center wavelengths of the AWG chips are shifted.

In contrast, in the AWG multiplexer-demultiplexer 100 according to the present embodiment, the movable piece 72 is slid by the compensation member 40 expanding/contracting in a direction D according to a change in temperature of the AWG multiplexer-demultiplexer 100 and relative positions of the fixed piece 71 and the movable piece 72 are changed, to thereby compensate for a temperature-dependent shift in the light transmission center wavelength of the AWG chip 10. Athermalization of the AWG multiplexer-demultiplexer 100 is thereby realized.

Particularly, the compensation member 40 extends substantially in parallel with the cut surface C of the first slab waveguide 10Ab, and thus, the direction D of its expansion/contraction is also substantially parallel to the cut surface C. Accordingly, a width of the groove G hardly changes even if the compensation member 40 expands/contracts. As a result, optical properties of the AWG multiplexer-demultiplexer 100 do not vary and are stabilized even if the compensation member 40 expands/contracts.

Further, the clip 50 applies the pressing force F to sandwich the reference plate 30 and the movable piece 72. As a result, even if the compensation member 40 expands/contracts and relative positions of the fixed piece 71 and the movable piece 72 are changed, an optical axis of the AWG multiplexer-demultiplexer 100 is maintained unchanged, and thus the optical properties are stabilized.

Here, in the present embodiment, since the fixed piece 71 is joined to the reference plate 30, the clip 50 needs to press only the movable piece 72 against the reference plate 30. Accordingly, the pressing force F to be applied by the clip 50 may be small. The clip 50 may therefore be small and simple, and a cost for its part is thus reduced. Further, the clip 50 does not need to use a complex and expensive part such as a holding substrate because only the movable piece 72 needs to be pressed against the reference plate 30, and thus, lower cost and further downsizing are able to be realized.

Furthermore, in the present embodiment, since the movable piece 72 to be sandwiched by the clip 50 has a smaller mass than the fixed piece 71 joined to the reference plate 30, the clip 50 may be further downsized and simplified.

In contrast, conventionally, a pressing force needs to be applied to both of two pieces separated by cutting an AWG chip, and thus a clip having a large pressing force and of a large size needs to be used. Further, an additional part, such as a holding substrate, is necessary for appropriately applying the pressing force to both of the two pieces.

As described above, the AWG multiplexer-demultiplexer 100 according to the present embodiment is downsized and inexpensive, and has stable optical properties.

An amount of position correction dx by the compensation member 40 for compensating the temperature-dependent shift of the light transmission center wavelength of the AWG chip 10, may be set by the following equation (1) using circuit parameters or the like of the AWG chip 10.

$$d x = \frac{{L}_{f} Δ L}{{n}_{s} d {λ}_{0}} {n}_{g} \frac{d λ}{d T} Δ T \qquad ( 1 )$$

Here, L_{f} is a focal length of the first slab waveguide 10Ab, ΔL is an optical path difference of adjacent channel waveguides of the arrayed waveguide 10Ac, d is a pitch between adjacent channel waveguides of the arrayed waveguide 10Ac, nₛ is an effective refractive index of the first slab waveguide 10Ab, n_{g} is a group refractive index of the arrayed waveguide 10Ac, d?/dT is temperature dependence of the transmission center wavelength (for example, 0.011 nm/° C.), and ΔT is an amount of temperature change. Further, λ₀ is a wavelength at which a diffraction angle in the first slab waveguide 10Ab becomes 0 degrees and which is called a center wavelength of the AWG.

When the amount of temperature change is ΔT, by setting the linear thermal expansion coefficient and a length of the compensation member 40 such that the movable piece 72 slides by the amount of position correction dx indicated by equation (1), the temperature dependent shift of the light transmission center wavelength of the AWG chip 10 is able to be compensated.

Next, a method of manufacturing the AWG chip 10 will be described. First, silica materials (SiO₂ based glass particles) to become a lower cladding layer and a core layer are sequentially deposited on a substrate formed of silicon, silica glass, or the like by a flame hydrolysis deposition (FHD) method, and the deposited layers are melted and made transparent by heating. Next, a core layer is formed in waveguide patterns of a plurality of AWGs 10A using photolithography and reactive ion etching. Subsequently, an upper-and-side cladding layer is formed by the FHD method again so as to cover upper and side portions of the waveguide patterns.

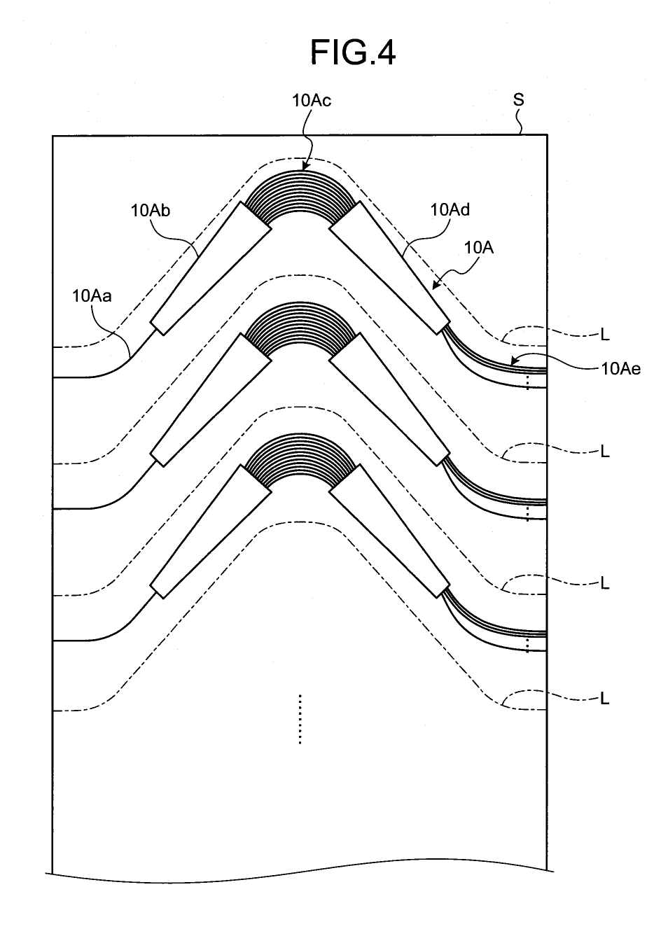

Next, as illustrated in FIG. 4, a plurality of AWGs 10A, each composed of the first input-output waveguide 10Aa, the first slab waveguide 10Ab, the arrayed waveguide 10Ac, the second slab waveguide 10Ad, and the plurality of second input-output waveguides 10Ae and formed on a substrate S are cut along cutting lines L along the outline shape of the AWGs 10A using a CO₂ laser. Thereby, the AWG chips 10 having a boomerang shape along the outline shape of the AWGs 10A are able to be obtained. The cutting may be performed using various lasers, water jets, and the like for processing, without being limited to the CO₂ laser.

As described, by highly densely forming the AWGs 10A on the substrate S, cutting into the boomerang shapes along the outline shapes of the AWGs 10A, and obtaining the AWG chips 10, a greater number of AWG chips 10 is obtainable from one substrate S than when cutting the substrate into rectangular shapes each including the AWG. Accordingly, the AWG chips 10 are able to be manufactured at a low cost.

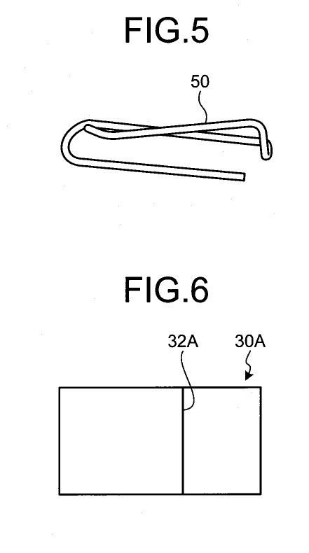

Next, the clip 50 will be described. FIG. 5 is a schematic perspective view of the clip 50 illustrated in FIG. 1. As illustrated in FIG. 5, the clip 50 is formed by bending one rod in a rounded oblong shape to form a bottom portion, further bending it to form a standing portion extending upward, bending it to form a sloping portion sloping therefrom toward the bottom portion below, and finally bending an end portion upward to form a holding portion. Upon use, the reference plate 30 and the movable piece 72 are inserted and sandwiched between the bottom portion and the holding portion of the clip 50, as illustrated in FIGS. 1 and 2. The movable piece 72 is able to be pressed against the reference plate 30 with a sufficient pressing force by the clip 50 having such a simple structure. Further, such a clip 50 is low in height and is suitable for downsizing.

(Modified Example of Reference Plate)

Next, a modified example of a reference plate that may be used instead of the reference plate 30 will be described. According to the AWG multiplexer-demultiplexer 100 of the present embodiment, the fixed piece 71 is joined to the reference plate 30 by an adhesive or the like, and the movable piece 72 is abutted against the reference plate 30. As a result, depending on a thickness of the adhesive or the like, heights of the fixed piece 71 and the movable piece 72 will differ from each other, resulting in a difference between heights of the AWG chip piece 11 and the AWG chip piece 12 included in the movable piece 72, which may lead to a deviation of an optical axis of the first slab waveguide 10Ab. According to a reference plate of a modified example described below, the difference in the heights of the AWG chip piece 11 and the AWG chip piece 12 is infallibly prevented.

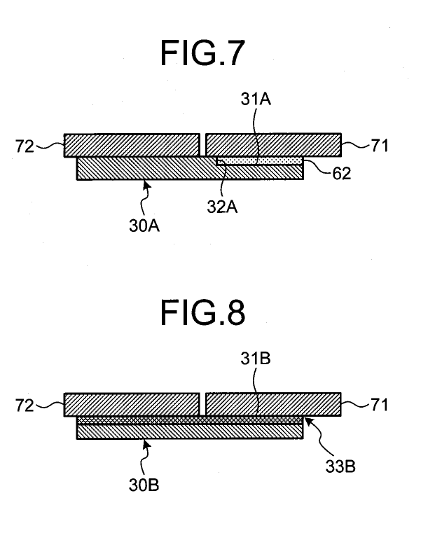

FIG. 6 is a schematic top view of a reference plate 30A according to a modified example 1. FIG. 7 is a side view illustrating a state where the fixed piece 71 is joined to, and the movable piece 72 is abutted against, the reference plate 30A illustrated in FIG. 5. As illustrated in FIGS. 6 and 7, the reference plate 30A according to the modified example 1 has a step 32A formed in a region 31A to which the fixed piece 71 is joined, by a thickness thereof being thinner than a region against which the movable piece 72 is abutted. As a result, an adhesive 62 for attaching the fixed piece 71 to the reference plate 30A is filled in between the region 31A where the thickness is thin and the fixed piece 71, and also, an end portion of the fixed piece 71, the end portion being closer to the movable piece 72, is abutted against a region against which the movable piece 72 is abutted. Therefore, the fixed piece 71 is not shifted in a height direction by the adhesive either, and thus the height difference between the AWG chip piece 11 and the AWG chip piece 12 is infallibly prevented.

FIG. 8 is a schematic side view illustrating a state where the fixed piece 71 is joined to, and the movable piece 72 is abutted against, a reference plate 30B according to a modified example 2. As illustrated in FIG. 8, the reference plate 30B according to the modified example 2 has its region 31B on its entire surface roughened by a frosting process. Upon joining the fixed piece 71 to the reference plate 30B, when an adhesive is supplied from an end portion 33B of the reference plate 30B, the end portion 33B being closer to the fixed piece 71, the adhesive seeps and fills into concave portions of the region 31B that has been subjected to the frosting process, and the fixed piece 71 is thus able to be joined to the reference plate 30B. Therefore, the fixed piece 71 is not shifted in the height direction by the adhesive, and the height difference between the AWG chip piece 11 and the AWG chip piece 12 is infallibly prevented. Further, the frosting process is also performed on a region of the surface of the reference plate 30B against which the movable piece 72 is to be abutted. As a result, a contact area between the reference plate 30B and the movable piece 72 is reduced and a frictional force therebetween is reduced, and the movable piece 72 is enabled to slide smoothly by the expansion/contraction of the compensation member 40. The extent of roughness of the frosting process is an extent to which a sufficient amount of adhesive smoothly enters the concave portions and to which smoothness that prevents tilting due to the roughness upon the joining of the fixed piece 71 or the abutment of movable piece 72 is maintained, and a surface roughness Ra is preferably 10 μm or less, for example.

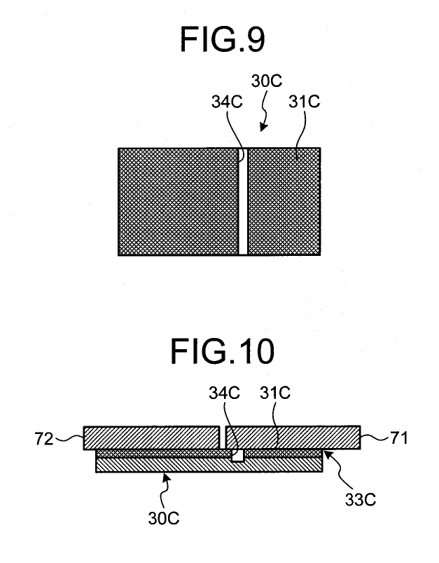

FIG. 9 is a schematic top view of a reference plate 30C according to a modified example 3. FIG. 10 is a side view illustrating a state where the fixed piece 71 is joined to, and the movable piece 72 is abutted against, the reference plate 30C illustrated in FIG. 9. As illustrated in FIGS. 9 and 10, the reference plate 30C according to the modified example 3 has its region 31C on the entire surface thereof roughened by the frosting process, and has a groove 34C formed substantially along a cut surface of the AWG chip, the groove 34C being below the fixed piece 71 and closer to where the movable piece 72 is abutted. The groove 34C may be formed by dicing or the like, for example. With the reference plate 30C, in addition to the effect of the reference plate 30B according to the modified example 2, when an adhesive is supplied from an end portion 33C of the reference plate 30C, the end portion 33C being closer to the fixed piece 71, the adhesive that has seeped into concave portions of the region 31C that has been subjected to the frosting process, upon having flowed towards the movable piece 72, stays in the groove 34C. This prevents the adhesive from flowing to the movable piece 72. Thus, an area over which the fixed piece 71 is joined is more infallibly manageable, and the movable piece 72 is prevented from erroneously being joined to the reference plate 30C.

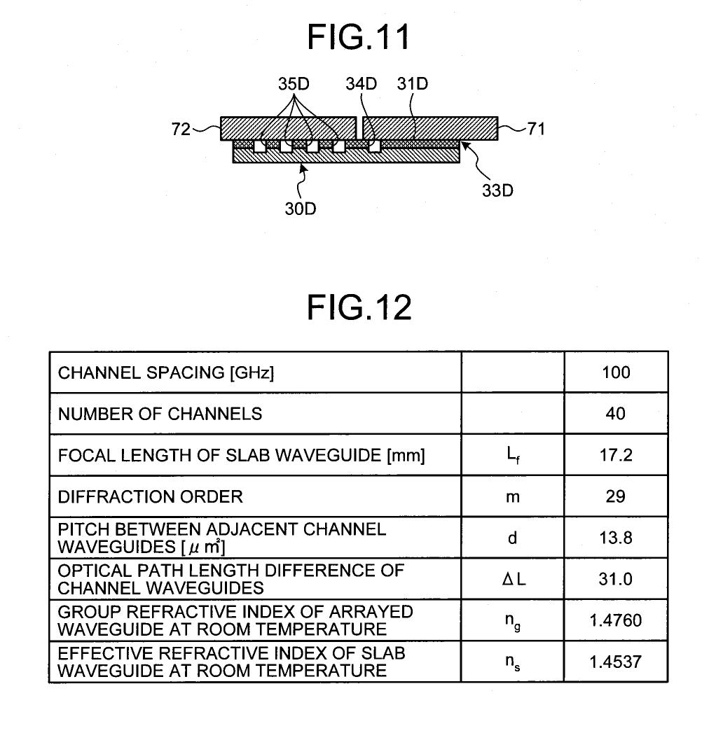

FIG. 11 is a schematic side view illustrating a state where the fixed piece 71 is joined to, and the movable piece 72 is abutted against, a reference plate 30D according to a modified example 4. As illustrated in FIG. 11, the reference plate 30D according to the modified example 4 has its region 31D on the entire surface thereof roughened by a frosting process, and has grooves 34D and 35D formed substantially along a cut surface of the AWG chip, below the fixed piece 71 and closer to where the movable piece 72 is abutted, as well as in a region against which the movable piece 72 is abutted, respectively. An adhesive is supplied from an end portion 33D of the reference plate 30C, the end portion 33D being closer to the fixed piece 71. With the reference plate 30D, in addition to the effect of the reference plate 30C according to the modified example 3, since the frictional force between the reference plate 30D and the movable piece 72 is reduced by the grooves 35D, the movable piece 72 is able to slide smoothly by the expansion/contraction of the compensation member 40.

### Example

An AWG multiplexer-demultiplexer having a configuration of the embodiment illustrated in FIG. 1 was manufactured as an example of the present invention. A reference plate having a configuration of the modified example 4 illustrated in FIG. 11 was used as the reference plate. FIG. 12 is a diagram illustrating circuit parameters of the AWG multiplexer-demultiplexer of the example. Using these circuit parameters, a length of a compensation member made of pure aluminum (JIS: A1050) was set to 18.0 mm.

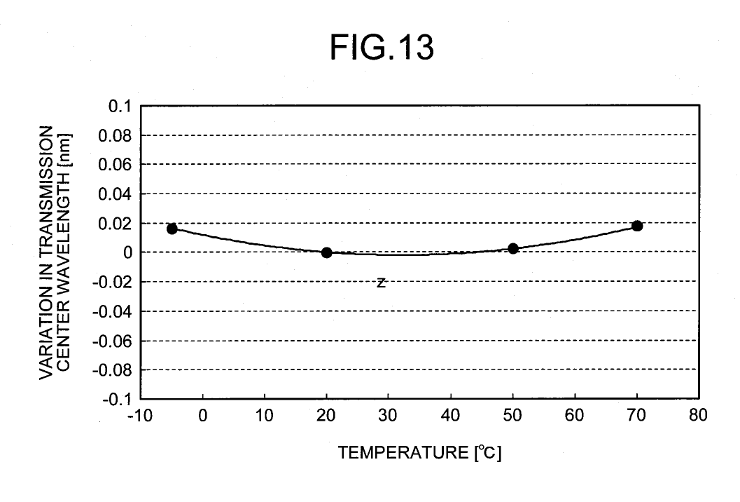

FIG. 13 is a diagram illustrating temperature dependence of variation in transmission center wavelength of the AWG multiplexer-demultiplexer of the example. As illustrated in FIG. 13, the variation in the transmission center wavelength of the AWG multiplexer-demultiplexer of the example is ±0.010 nm in a wide temperature range of −5° C. to 70° C., and very good temperature characteristics were demonstrated.

In the embodiment described above, of those obtained by cutting and separating the AWG chip, one with a smaller mass is pressed by the clip as the movable piece, but one with a larger mass may be pressed by the clip as the movable piece. That is, by pressing one of the separated AWG chips against the reference plate by the clip, and joining and fixing the other to the reference plate, the clip is able to be made smaller and simpler.

Further, in the embodiment described above, the first slab waveguide is cut and separated, but the second slab waveguide or both the first slab waveguide and the second slab waveguide may be cut and separated. That is, a plurality of the fixed pieces and movable pieces described above may be formed by cutting the AWG chip and the base plate at at least one of the cut surface crossing the first slab waveguide and the cut surface crossing the second slab waveguide. In this case, one or more compensation members described above may be provided correspondingly with the number of pairs of the fixed piece and the movable piece. For example, the compensation members described above may be joined respectively between: the fixed piece and the movable piece separated by the cut surface of the first slab waveguide; and the fixed piece and the movable piece separated by the cut surface of the second slab waveguide. Further, one or more clips described above may be provided correspondingly with the number of the movable pieces formed. For example, the clips described above may be provided respectively to the movable piece closer to the cut surface of the first slab waveguide and the movable piece closer to the cut surface of the second slab waveguide, and each of these clips may sandwich the respective one of the movable pieces and the reference plate.

Further, in the embodiment described above, the AWG chip having the boomerang shape is obtained by cutting the substrate along the outline shape of the AWG, but a rectangular AWG chip may be obtained by cutting the substrate into a rectangular shape. In this case, if the AWG chip has a space, a compensation member may be provided to bridge between two AWG chip pieces, which have been separated.

Further, in the embodiment described above, a frosting process is performed on the surface of the reference plate, but another roughening process such as sand blasting, shot blasting, satin processing, creping processing, or the like may be performed. Further, a roughening process such as a frosting process is performed or a groove is provided to enable smooth sliding of the movable piece, but a mode thereof is not particularly limited, as long as there is a dent portion that reduces the contact area between the movable piece and the reference plate. Further, if a groove is to be provided, a direction in which the groove extends is not limited to the direction following the cut surface of the AWG chip and may be a direction perpendicular to the cut surface.

Further, the constituent material of the base plate or the reference plate is not limited to silica glass. Various materials such as metals, semiconductors, ceramics, and the like may be used as long as the length of the compensation member is determined taking into account the linear thermal expansion coefficient of the constituent material of the base plate or the reference plate.

Furthermore, the position at which the AWG chip and the base plate are joined and the position at which the compensation member is bridged are not limited to those of the embodiment, and may be any position as long as the positions of the cut AWG chips are relatively changeable by the expansion/contraction of the compensation member.

Moreover, the present invention is not limited by the embodiment described above. Configurations obtained by combining the structural elements described above as appropriate are also included in the present invention. In addition, other embodiments, examples, application techniques, and the like achieved by those skilled in the art based on the embodiment described above are all included in the present invention.

According to an embodiment of the disclosure, an arrayed waveguide grating multiplexer-demultiplexer of low cost and having stable optical properties is able to be realized.

What is claimed is:

1. An arrayed waveguide grating multiplexer-demultiplexer comprising:
an arrayed waveguide grating chip including:
a first input-output waveguide to and from which light is input and output;
a first slab waveguide connected to the first input-output waveguide;
an arrayed waveguide connected to the first slab waveguide and formed of a plurality of channel waveguides that have mutually different lengths and are arranged parallel to one another;
a second slab waveguide connected to the arrayed waveguide; and
a plurality of second input-output waveguides connected to the second slab waveguide, and to and from which light is input and output;
a base plate joined to an underside of the arrayed waveguide grating chip;
a fixed piece and a movable piece that are formed by the arrayed waveguide grating chip and the base plate being cut into a plurality of pieces at at least one of a cut surface crossing the first slab waveguide and a cut surface crossing the second slab waveguide;
a reference plate to which the fixed piece is joined and against which the movable piece is abutted;
one or more compensation member or members that is or are provided to bridge between the fixed piece and the movable piece, and compensates a temperature-dependent shift of a light transmission center wavelength of the arrayed waveguide grating multiplexer-demultiplexer by expanding or contracting according to a temperature change and changing relative positions of the fixed piece and the movable piece; and
one or more clip or clips that sandwiches or sandwich the reference plate and the movable piece so as to allow the movable piece to slide on the reference plate.

2. The arrayed waveguide grating multiplexer-demultiplexer according to claim 1, wherein a mass of the movable piece is smaller than a mass of the fixed piece.

3. The arrayed waveguide grating multiplexer-demultiplexer according to claim 1, wherein the clip is formed by bending one rod.

4. The arrayed waveguide grating multiplexer-demultiplexer according to claim 1, wherein the reference plate has a step formed in a region to which the fixed piece is joined, the step being formed by a thickness of the reference plate being thinner than a region against which the movable piece is abutted, and an end portion of the fixed piece, the end portion being closer to the movable piece, is abutted against the region to which the movable piece is abutted.

5. The arrayed waveguide grating multiplexer-demultiplexer according to claim 1, wherein a surface of the reference plate is roughened in a region to which the fixed piece is joined.

6. The arrayed waveguide grating multiplexer-demultiplexer according to claim 5, wherein on a surface of the reference plate, below the fixed piece and closer to where the movable piece is abutted, a groove is formed substantially along a cut surface of the arrayed waveguide grating chip.

7. The arrayed waveguide grating multiplexer-demultiplexer according to claim 1, wherein a surface of the reference plate is roughened in a region against which the movable piece is abutted.

8. The arrayed waveguide grating multiplexer-demultiplexer according to claim 1, wherein a dent portion is formed on a surface of the reference plate, in a region against which the movable piece is abutted.

9. The arrayed waveguide grating multiplexer-demultiplexer according to claim 1, wherein the arrayed waveguide grating chip has a shape following along an outline shape of an arrayed waveguide grating thereof.

10. The arrayed waveguide grating multiplexer-demultiplexer according to claim 9, wherein the compensation member is provided to bridge between the base plate of the fixed piece and the base plate of the movable piece.
